(19) United States
(12) Patent Application Publication
(10) Pub. No.: US 2013/0307787 A1
(43) Pub. Date: Nov. 21, 2013

(54) PORTABLE ELECTRONIC DEVICE AND METHOD OF CONTROLLING SAME

(71) Applicants: James Alexander Robinson, Elmira (CA); John Edward Dolson, Carp (CA); William Turlay Stacy, San Jose, CA (US); Robert James Lowles, Waterloo (CA)

(72) Inventors: James Alexander Robinson, Elmira (CA); John Edward Dolson, Carp (CA); William Turlay Stacy, San Jose, CA (US); Robert James Lowles, Waterloo (CA)

(73) Assignee: Research In Motion Limited, Waterloo (CA)

(21) Appl. No.: 13/473,127

(22) Filed: May 16, 2012

(51) Int. Cl. G06F 3/041

(52) U.S. Cl. 345/173

(57) ABSTRACT

A method includes detecting, by a touch-sensitive display of a first electronic device, presence of a touch-sensitive display of a second electronic device. A data signal is transmitted from the first electronic device to the second electronic device by applying a drive signal to drive lines of the touch-sensitive display of the first electronic device. The touch-sensitive display of the second electronic device may the received a signal associated with the applied drive signal.

### FIELD OF TECHNOLOGY

The present disclosure relates to electronic devices, including but not limited to, portable electronic devices having touch-sensitive displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart phones, wireless personal digital assistants (PDAs), and laptop computers with wireless 802.11 or Bluetooth capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified based on the functions and operations being performed. With continued demand for decreased size of portable electronic devices, touch-sensitive displays continue to decrease in size.

Improvements in devices with touch-sensitive displays are desirable.

### BRIEF DESCRIPTION OF THE DRAWINGS

FIG. 1 is a block diagram of a portable electronic device in accordance with the disclosure.

FIG. 2 shows a cross-sectional side view of a touch-sensitive display in accordance with the disclosure.

FIG. 3 shows a top view of touch sensors in accordance with the disclosure.

FIG. 4 is a flowchart illustrating a method of transmitting data from one touch-sensitive display to another touch-sensitive display in accordance with the disclosure.

FIG. 5 is a flowchart illustrating a method of receiving data from a touch-sensitive display transmitted by another touch-sensitive display in accordance with the disclosure.

FIG. 6 illustrates two touch-sensitive displays in relationship to transmit data in accordance with the disclosure.

### DETAILED DESCRIPTION

The following describes an apparatus and method of communicating data, from a capacitive touch-sensitive display of one electronic device to a capacitive touch-sensitive display of another electronic device. The touch-sensitive display of each electronic device may detect the presence of the other touch-sensitive display. A first electronic device transmits a data signal to the other electronic device by applying a drive signal applied to the drive lines of the touch-sensitive display of the first electronic device. The touch-sensitive display of the other electronic device may receive a signal associated with the applied drive signal, which received signal is processed or analyzed to recover the data signal.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

The disclosure generally relates to an electronic device, such as a portable electronic device as described herein. Examples of electronic devices include mobile, or handheld, wireless communication devices such as pagers, cellular phones, cellular smart-phones, wireless organizers, personal digital assistants, wirelessly enabled notebook computers, tablet computers, mobile internet devices, electronic navigation devices, and so forth. The electronic device may be a portable electronic device without wireless communication capabilities, such as a handheld electronic game, digital photograph album, digital camera, media player, e-book reader, and so forth.

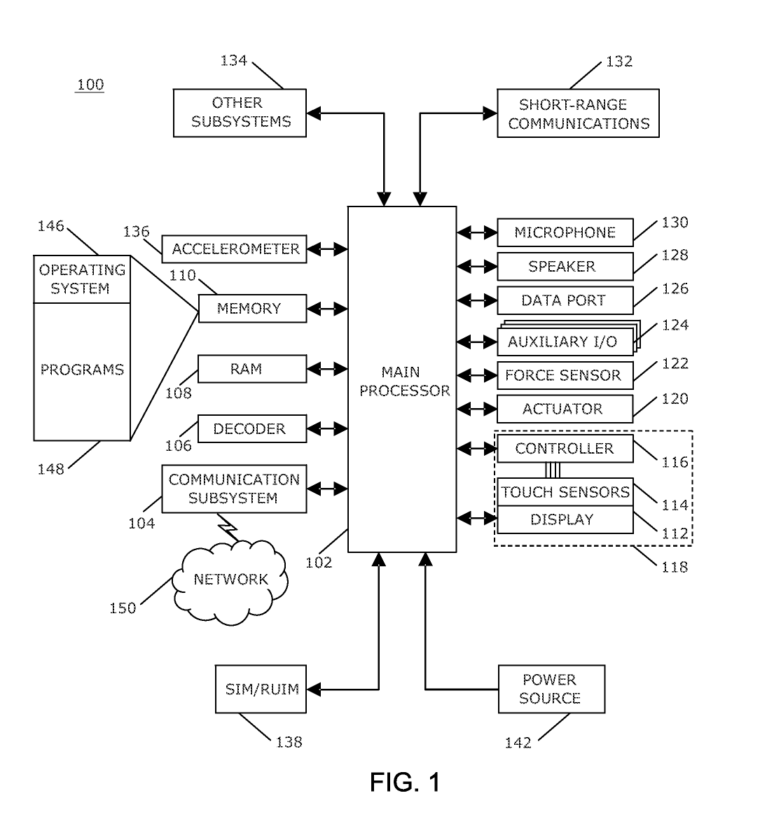

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as a Random Access Memory (RAM) 108, memory 110, a touch-sensitive display 118, one or more actuators 120, one or more force sensors 122, an auxiliary input/output (I/O) subsystem 124, a data port 126, a speaker 128, a microphone 130, short-range communications 132 and other device subsystems 134. The touch-sensitive display 118 includes a display 112 and touch sensors 114 that are coupled to at least one controller 116 that is utilized to interact with the processor 102. Input via a graphical user interface is provided via the touch-sensitive display 118. Information, such as text, characters, symbols, images, icons, and other items that may be displayed or rendered on a portable electronic device, is displayed on the touch-sensitive display 118 via the processor 102. The processor 102 may also interact with an accelerometer 136 that may be utilized to detect direction of gravitational forces or gravity-induced reaction forces.

To identify a subscriber for network access, the portable electronic device 100 may utilize a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs, applications, or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth. A capacitive touch-sensitive display includes one or more capacitive touch sensors 114. The capacitive touch sensors may comprise any suitable material, such as indium tin oxide (ITO).

One or more touches, also known as touch contacts or touch events, may be detected by the touch-sensitive display 118. The processor 102 may determine attributes of the touch, including a location of the touch. Touch location data may include data for an area of contact or data for a single point of contact, such as a point at or near a center of the area of contact. The location of a detected touch may include x and y components, e.g., horizontal and vertical components, respectively, with respect to one's view of the touch-sensitive display 118. For example, the x location component may be determined by a signal generated from one touch sensor, and the y location component may be determined by a signal generated from another touch sensor. A touch may be detected from any suitable input member, such as a finger, thumb, appendage, or other objects, for example, a stylus, pen, or other pointer, based on the nature of the touch-sensitive display 118. Multiple simultaneous touches may be detected.

One or more gestures may also be detected by the touch-sensitive display 118. A gesture, such as a swipe, also known as a flick, is a particular type of touch on a touch-sensitive display 118 and may begin at an origin point and continue to an end point, for example, a concluding end of the gesture. A gesture may be identified by attributes of the gesture, including the origin point, the end point, the distance traveled, the duration, the velocity, and the direction, for example. A gesture may be long or short in distance and/or duration. Two points of the gesture may be utilized to determine a direction of the gesture. A gesture may also include a hover. A hover may be a touch at a location that is generally unchanged over a period of time or is associated with the same selection item for a period of time.

The touch-sensitive display 118 includes a display area in which information may be displayed, and a non-display area extending around the periphery of the display area. The display area generally corresponds to the area of the display 112. Information is not displayed in the non-display area by the display, which non-display area is utilized to accommodate, for example, electronic traces or electrical connections, adhesives or other sealants, and/or protective coatings around the edges of the display area. The non-display area may be referred to as an inactive area and is not part of the physical housing or frame of the electronic device. Typically, no pixels of the display are in the non-display area, thus no image can be displayed by the display 112 in the non-display area. Optionally, a secondary display, not part of the primary display 112, may be disposed under the non-display area. Touch sensors may be disposed in the non-display area, which touch sensors may be extended from the touch sensors in the display area or distinct or separate touch sensors from the touch sensors in the display area. A touch, including a gesture, may be associated with the display area, the non-display area, or both areas. The touch sensors may extend across substantially the entire non-display area or may be disposed in only part of the non-display area.

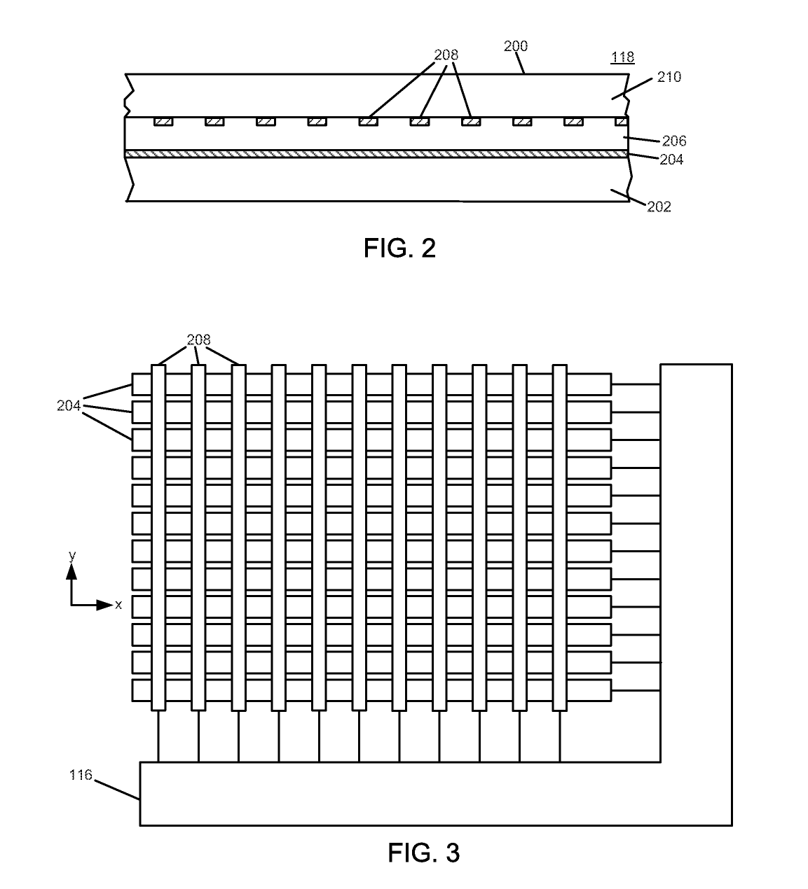

A cross-sectional side view of part of the touch-sensitive display 118 is illustrated in FIG. 2. The touch-sensitive display 118 may be, for example, a projected-capacitive touch-sensitive display, such as a mutual capacitive touch-sensitive display or a self-capacitive touch-sensitive display. The touch-sensitive display 118 may include a capacitive touch-sensitive overlay 200. The overlay 200 may be an assembly of multiple layers in a stack including, for example, a first substrate 202, a lower set of conductors 204, a second substrate or non-conductive layer or barrier 206, an upper set of conductors 208, and a cover 210. Alternatively, the overlay 200 may comprise a single substrate 206 with the lower conductors 204 deposited on the lower surface of the substrate 206 and the upper conductors 208 deposited on the upper surface of the substrate 206, and a cover 210. The conductors 204, 208 may be, for example, any translucent or transparent conductive material, such as indium tin oxide (ITO).

The terms upper, lower, horizontal, vertical, and so forth are utilized to provide a perspective with respective to viewing the drawings and are not otherwise limiting.

The lower conductors 204 may be disposed on the first substrate 202, for example, by depositing the conductor material on the substrate. The upper conductors 208 may be disposed on the second substrate 206. The substrates 202 and 206 may comprise any non-conductive material that separates the lower conductors 204 from the upper conductors 208. The substrates may advantageously be a transparent dielectric material. The substrates 202 and 206 may comprise, for example, transparent plates comprised of polyethylene terephthalate, polyester, glass, or other suitable material. Alternatively, the lower conductors may be disposed or deposited on the display 112, eliminating the first substrate 202 in this example.

The optional cover 210 may be a protective covering and may comprise, for example, a see-through or translucent material, such as plastic or glass. The upper conductors 208 may optionally be disposed or deposited on the cover 210. When the first substrate 202 is eliminated and the upper conductors are disposed on the cover 210, the layer 206 may be a non-conductive barrier disposed between the conductors 204, 208.

An example of a top view of lower conductors 204 and upper conductors 208 is shown in FIG. 3. The quantity of conductors 204, 208 may be any suitable number and may be based on, for example, the size of the display 112, the shape of the display 112, the material of the conductors 204, 208, and so forth.

The lower conductors 204 and the upper conductors 208 are typically arranged in a layer of rows and a layer of columns, e.g., separated by the second substrate or layer 206. For example, the lower conductors 204 may extend in a direction that is generally at a right angle or perpendicular to the upper conductors 208 to form a grid. For example, the lower conductors 204 may be generally parallel bars or lines extending across the display horizontally, and the upper conductors 208 may be generally parallel bars or lines extending across the display vertically, or vice versa. The areas where the upper conductors 208 pass over the lower conductors 204, or, areas where the upper conductors 208 and the lower conductors 204 have the same x and y coordinates, are referred to as nodes.

In a touch-sensitive display based on detecting mutual capacitance, a touch on the touch-sensitive display 118 changes the local electric field and changes, e.g., reduces, the mutual capacitance between the upper conductors 208 and the lower conductors 204 at the nodes. The change in capacitance may be measured to determine the touch location.

The conductors 204, 208 are electrically coupled to the controller 116, such as by routing traces, e.g., conductive metal traces, utilized to couple the conductors to bonding pads on one side of the overlay. In the example illustrated in FIG. 3, the lower conductors 204 may be utilized as drive lines, and the upper conductors 208 may be utilized as sense lines. Alternatively, the upper conductors 208 may be utilized as drive lines, and the lower conductors 204 may be utilized as sense lines.

A drive signal, such as a pulsed voltage signal, an alternating current, or other suitable drive signal, is applied to one set of conductors 204, 208, e.g., the drive lines. The drive lines of touch-sensitive displays for portable electronic devices are typically driven at a frequency between about 40 kHz and about 200 kHz. When an input member is near the surface of the overlay 200, the electric field near the input member changes, which reduces the mutual capacitance. The capacitance change at individual nodes on the grid may be measured to determine the touch location, e.g., by measuring an electrical characteristic such as the voltage or current at the other set of conductors 204, 208, e.g., the sense lines.

The drive lines and the sense lines are typically scanned, e.g., each row is driven separately in sequence, while the columns sense simultaneously or sequentially, or vice versa. The controller 116 may control timing of the driving and sensing, and may control the driving signals, such as their timing, voltage amplitude, pulse duration, frequency, and so forth.

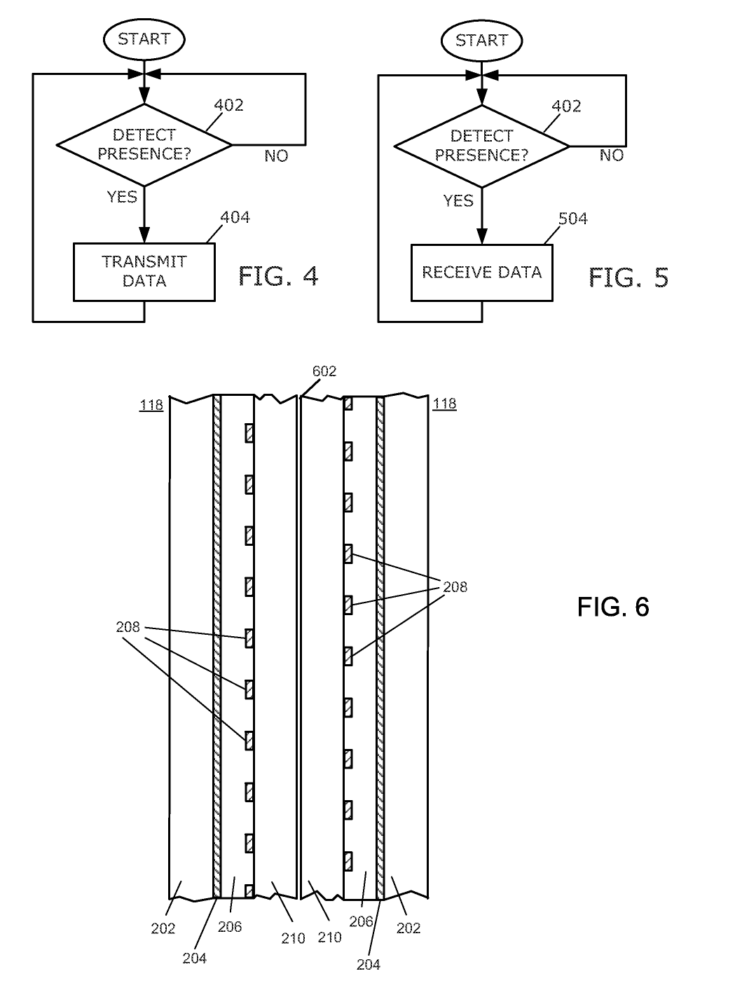

A capacitive touch-sensitive display 118 of an electronic device 100 may be utilized for communication, such as the short-range communication of data, with another electronic device having a capacitive touch-sensitive display. The capacitive touch-sensitive display is utilized to transmit and/or receive data. A flowchart illustrating transmitting data is shown in FIG. 4, and flowchart illustrating receiving data is shown in FIG. 5. The method may be carried out by software executed, for example, by the controller 116 and/or the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium or other computer-readable storage medium.

The touch-sensitive display of one electronic devices 100 detect 402 the presence of the other touch-sensitive display. A first electronic device 100, operating as a transmitting device, transmits 404 a data signal to the other electronic device 100 by applying a drive signal to the drive lines of its touch-sensitive display 118. The second electronic device 100, operating as a receiving device, receives 504, at sense lines of its touch-sensitive display 118, a received signal associated with the applied drive signal. The devices may switch roles to transmit information in the opposite direction.

An example of two touch-sensitive displays 118 in position, or arranged, for communication is shown in FIG. 6. The touch-sensitive display 118 of one electronic device 100 may be placed adjacent to or near, the touch-sensitive display 118 of another electronic device, e.g., face to face. The touch-sensitive displays 118 may be separated by a distance. The transmitting touch-sensitive display 118 transmits data to the receiving touch-sensitive display 118. Electric fields from the drive lines of the touch-sensitive display 118 extend outwardly beyond its cover 210 in a direction generally perpendicular to the plane of the outer surface of the cover 210. The distance that the electric fields extend from the drive lines is associated with design characteristics of the touch-sensitive display 118, such as the width of the drive lines, the conductive material of the conductors, the dielectric material of the covers 210, signal strength of the signal applied to the drive lines, and so forth. The lower conductors 204 may be the drive lines and the upper conductors 204 may be the sense lines. Alternatively, the upper conductors 204 may be the drive lines and the lower conductors 204 may be the sense lines.

When the electric field extending from the drive lines of the transmitting touch-sensitive display 118 interacts with the electric field extending from the conductors of the other touch-sensitive display 118, interference between the electric fields results. The interference may be constructive or destructive, also referred to as additive or subtractive. This interference may be sensed at the sense lines of the touch-sensitive displays 118.

The electric fields may extend a relatively short distance from the drive lines, e.g., less than 1 cm. In such an example, the distance separating the touch-sensitive displays 118 affects the magnitude of the interference, thus the magnitude of any change in capacitance detected by the receiving touch-sensitive display. The touch-sensitive displays 118 may, for example, be placed directly adjacent to one another or touching or the touch-sensitive displays may be separated by a small gap 602, e.g., less than 1 cm, to facilitate communication. Other distances may be facilitated by providing electric fields extending a different distance from the touch-sensitive display 118.

The interference between the electric fields extending from the touch-sensitive displays 118 may be utilized by one touch-sensitive display 118 to detect the presence of the other touch-sensitive display 118. For example, the interference between the electric fields may cause changes in capacitance at nodes of the touch-sensitive displays 118 that are interpreted as the presence of another touch-sensitive display. The touch data caused by presence of a touch-sensitive display 118 is different than the touch data caused by presence of an input member, e.g., one or more touches by a finger and/or stylus. The differences in the touch data may be analyzed by the touch-sensitive display 118 to identify the nature of the touch data, e.g., what type of input member, such as a finger, stylus, or other touch-sensitive display 118. The magnitude of the change of capacitance sensed at one or more nodes, the number of nodes, and/or the distribution of nodes at which a change in capacitance is detected, may indicate the presence of another touch-sensitive display. Alternatively, presence of one touch-sensitive display 118 near the other touch-sensitive display 118 may be detected by others sensors disposed in the electronic devices 100. Such other sensors may be, for example, proximity sensors, optical sensors, magnet and Hall effect sensors, and so forth.

Optionally, the electronic devices may be configured for, or enter, short-range communication prior to or instead of detecting the presence of one touch-sensitive display 118 at the other touch-sensitive display 118. For example, the touch-sensitive displays 118 may be configured to enter short-range communication through execution of an application; detection of an input, such as an actuation of an input device, such as a switch or keyboard key; selection of a function, such as selection of a virtual button, virtual key, or menu item displayed on the touch-sensitive display; and so forth.

In response to detecting 402 the presence of another touch-sensitive display 118, the electronic devices may optionally communicate to perform set up routines prior to transmitting data. For example, the touch-sensitive displays 602, 604 may be synchronized, e.g., the timing of drive and/or sense operations may be synchronized, such as by transmitting a pilot signal or other signal for time or phase synchronization between the devices. The devices may optionally perform a handshaking routine to negotiate parameters of communication between the electronic devices before communication of information or data begins. For example, the devices may perform a handshaking routine to determine data transmission rate, to determine interoperability between touch-sensitive displays 118 of different manufacturers, and/or to determine communication parameters between touch-sensitive displays 118 of different size.

When the presence of a touch-sensitive display 118 is detected, the drive signal is applied to the drive lines of the transmitting touch-sensitive displays 118 to transmit 404 data. The drive signal is generated from the data signal comprising the data to be transmitted. For example, the data may be hexadecimal data comprising “0” and “1” components. Each data component may be transmitted by all drive lines (across the display), some of the drive lines (across part of the display), or one of the drive lines (across a small part of the display) during a scan. The data signal transmitted in a single scan by the transmitting touch-sensitive display 118 may comprise multiple data components. Optionally, the drive signal may comprise additional data may be transmitted to facilitate error correction, synchronization, encryption, and/or other data transmission processes. Any suitable modulation technique may be applied to data to be transmitted. Example modulation techniques include frequency modulation, phase-shift modulation, and amplitude modulation. When the electric field is proportional to the change in voltage of the drive signal, the electric field extending from the drive lines of the transmitting touch-sensitive display 118 varies as the drive signal varies. The sense lines of the receiving touch-sensitive display 118 may sense changes in capacitance due to the drive signals applied to the drive lines of the transmitting touch-sensitive display 118.

For example, the varying electric field resulting from the modulated drive signals of the transmitting touch-sensitive display 118 interacts with the electric field extending from the receiving touch-sensitive display 118. In this example, the sense lines of the receiving touch-sensitive display 118 sense changes in capacitance caused by the interference between the electric fields.

Alternatively, the receiving touch-sensitive display 118 may sense during periods when its drive lines are inactive, such as between scans, or during a period when the drive lines are turned off, such as a period of time when the receiving device is configured to listen for a communication. The sense lines of the receiving touch-sensitive display 118 may sense changes in capacitance caused by the electric field extending from the touch-sensitive display of the transmitting device.

Practical considerations, such as noise, e.g., noise due to parasitic capacitance of the drive and sense lines, capacitive coupling between the touch-sensitive displays of the electronic devices, the available bandwidth of the communication channel, the frequency of the drive signal, the sensitivity of the sense lines, and so forth, may affect the data rate at which data may be communicated. Data may be transmitted at relatively low data rates, for example, less than 100 kHz. Thus, communication of relatively small data files may be facilitated. For example, data may be transmitted at relatively low data rates, such as contact information, small data files, compressed photographs, and so forth.

The sensing lines of the receiving touch-sensitive display 118 receive 504 a received signal caused by the transmitting touch-sensitive display 118 applying the drive signal generated from the data signal. The data in the data signal is converted from the received signal. For example, error correct, noise reduction, demodulation appropriate to any modulation utilized to create the drive signal, and other appropriate techniques may be applied to the received signal to recover the transmitted data.

To increase the amount of data transmitted, a first data signal may be applied to one subset of the drive lines of the transmitting touch-sensitive displays 118, and a second data signal may be applied to another subset of the drive lines. For example, one subset of drive lines may be located near one edge of the transmitting touch-sensitive display, and the other subset of the drive lines may be located near an opposing edge of the transmitting touch-sensitive display 118. The sense lines of the receiving touch-sensitive display 118 may be controlled to sense data signals in different areas of the touch-sensitive display 118, e.g., to sense the first data signal along the upper edge of the receiving touch-sensitive display 118 and to sense the second data signal along the lower edge of the receiving touch-sensitive display 118. To differentiate between the first data signal and the second data signal, the drive lines of the transmitting touch-sensitive display 118 and the sense lines of the receiving touch-sensitive display 118 are oriented in the same direction. For example, either the lower conductors 204 or the upper conductors 208 of the transmitting device may be utilized as drive lines, and the lower conductors 204 or the upper conductors 208 of the receiving device may be utilized as sense lines in any combination. One or more of the lower conductors 204 and the upper conductors 208 may be configurable as either drive lines or sense lines. Depending on the characteristics of the controller 116 and the ability to sense the other touch-sensitive display 118, the drive lines and sense lines may be reconfigured to optimize the signal to noise ratio of the data transfer between the devices 100 via the touch-sensitive displays 118. The identification of the drive and sense lines, the number of drive lines included in each subset, and the separation between the sets may be handled by the controller 116 or the processor 102, and may be based on, for example, the size of the display, the shape of the display, the total number of drive and sense lines available, the sensitivity of the sense lines at the receiving touch-sensitive display, and so forth.

Data communication between electronic devices having mutual-capacitance touch-sensitive displays is described. Data communication between touch-sensitive displays of electronic devices may be applied to electronic devices including other touch-sensitive displays, such as self-capacitance, in-cell, and on-cell touch-sensitive displays, for example.

The ability to communicate data between touch-sensitive displays is provided. Communicating data by applying a drive signal of a transmitting touch-sensitive display and receiving the data by sense lines of a receiving touch-sensitive display does not require additional or specialized hardware. The existing drive and sense lines of each touch-sensitive display may be utilized to communicate data. Such communication may be advantageous for transmitting and receiving small amounts of data, such as contact information, small data files, compressed photographs, and so forth, and may replace or supplement other transmission techniques such as optical bar code reading, Radio Frequency Identification (RFID), Near Field Communication (NFC), and so forth, each of which requires hardware not necessarily present in an electronic device.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method comprising:
detecting, by a touch-sensitive display of a first electronic device, presence of a touch-sensitive display of a second electronic device;
transmitting a data signal from the first electronic device to the second electronic device by applying a drive signal to drive lines of the touch-sensitive display of the first electronic device.

2. The method according to claim 1, further comprising receiving, at a touch sensitive display of the second electronic device, a received signal associated with the applied drive signal.

3. The method according to claim 2, wherein the receiving comprises detecting the drive signal at sense lines of the touch-sensitive display of the second electronic device.

4. The method according to claim 2, further comprising demodulating the received signal to retrieve the data signal.

5. The method according to claim 1, wherein transmitting comprises applying the drive signal to a subset of the drive lines of the touch-sensitive display of the first electronic device.

6. The method according to claim 1, further comprising detecting, by a subset of sense lines of the touch-sensitive display of the second electronic device, the received signal associated with the drive signal.

7. The method according to claim 1, wherein the detecting comprises detecting a change in capacitance.

8. The method according to claim 1, further comprising, in response to the detecting, synchronizing timing of the touch-sensitive display of the first electronic device with timing of the touch-sensitive display of the second electronic device.

9. The method according to claim 1, further comprising, in response to the detecting, performing a handshake routine between the first electronic device and the second electronic device.

10. The method according to claim 1, wherein the detecting comprises detecting when the touch-sensitive display of the second electronic device is 0 cm to 1 cm from the touch-sensitive display of the first electronic device.

11. A computer-readable storage medium having computer-readable code executable by at least one processor of the first electronic device to perform the method of claim 1.

12. A method comprising:
detecting, by a touch-sensitive display of a second electronic device, presence of a touch-sensitive display of a first electronic device;
receiving, at sense lines of the touch-sensitive display of the second electronic device, a received signal resulting from a drive signal applied to drive lines of the touch-sensitive display of the first electronic device.

13. The method according to claim 12, wherein the receiving comprises detecting, at the sense lines, changes in an electrical characteristic associated with the received signal.

14. The method according to claim 12, wherein the detecting comprises detecting interference with an electric field at the touch-sensitive display of the second device.

15. The method according to claim 12, wherein the detecting comprises detecting a change in capacitance.

16. A computer-readable storage medium having computer-readable code executable by at least one processor of the second electronic device to perform the method of claim 12.

17. An electronic device comprising:
a touch-sensitive display;
a processor coupled to the touch-sensitive display and configured to:
detect presence of a touch-sensitive display of a second electronic device;
transmit a data signal from the electronic device to the second electronic device by applying a drive signal to drive lines of the touch-sensitive display of the electronic device.

18. The electronic device according to claim 17, further comprising sense lines to receive a signal generated by drive lines of the touch-sensitive display of the other electronic device.

19. The electronic device according to claim 17, wherein the processor is further configured to synchronize timing of the touch-sensitive display of the electronic device to timing of the touch-sensitive display of the second electronic device.
